(19) United States
(12) Patent Application Publication
(10) Pub. No.: US 2022/0071395 A1
(43) Pub. Date: Mar. 10, 2022

(54) PLASTIC FURNITURE WALL PART

(71) Applicant: Häfele Berlin GmbH & Co KG, Berlin (DE)

(72) Inventors: Peer Leistert, Schoeneiche (DE); Michael Von Wilcke, Birkenwerder (DE); Rico Marquardt, Besigheim (DE)

(73) Assignee: Häfele Berlin GmbH & Co KG, Berlin (DE)

(21) Appl. No.: 17/455,494

(22) Filed: Nov. 18, 2021

Related U.S. Application Data
(63) Continuation of application No. PCT/EP2020/061426, filed on Apr. 24, 2020.

(30) Foreign Application Priority Data
May 20, 2019 (DE) 20 2019 102 830.0

(51) Int. Cl. A47B 96/20; H04R 1/02

(52) U.S. Cl. CPC A47B 96/20; A47B 2220/0077; A47B 2220/0072; H04R 1/025

(57) ABSTRACT

A one-part plastic furniture wall part, in particular a plastic side wall part, includes a lattice-like skeleton structure which is closed toward the outside by an outer wall and is open toward the inside. The skeleton structure has at least one inwardly open recess for receiving a furniture fitting or an electrical component and/or at least one inwardly protruding functional element, in particular a pin.

### CROSS-REFERENCE TO RELATED APPLICATIONS

This continuation application claims priority to PCT/EP2020/061426 filed on Apr. 24, 2020 which has published as WO 2020/233940 A1 and also the German application number 20 2019 102 830.0 filed on May 20, 2019, the entire contents of which are fully incorporated herein with these references.

### DESCRIPTION

### Field of the Invention

The invention relates to a furniture wall part, in particular a side wall part, comprising at least one recess for receiving a furniture fitting or an electrical component.

### Background of the Invention

Furniture wall parts, such as for example side wall parts, are usually manufactured from wood-based material, wherein it is subsequently still necessary for apertures for furniture fittings or for electrical components to be milled individually into the furniture wall part.

By contrast, the present invention is based on the object of specifying a dimensionally stable furniture wall part which can be used in a versatile manner and on which it is preferably no longer necessary to carry out any subsequent work.

### SUMMARY OF THE INVENTION

This object is achieved by a one-part plastic furniture wall part, in particular a plastic side wall part, comprising a lattice-like skeleton structure which is closed toward the outside by an outer wall and is open toward the inside, wherein the skeleton structure comprises at least one inwardly open recess for receiving a furniture fitting or an electrical component and/or at least one inwardly protruding functional element, in particular a pin. The dependent claims relate to advantageous developments of the plastic furniture wall part according to the invention.

The plastic furniture wall part according to the invention can optionally be pre-equipped, in the available recesses, with predefined fittings and components which can be used to reproduce all the functions/applications conceivable in a carcass side wall. In addition to the typical furniture fittings, such as for example flap fittings, hinges or pull-out guides, the fittings and components also include components for the electrification of the furniture fittings and light units, sound systems, drive units and sensors, etc., and also other components to be supplied with power in the item of furniture. The plastic furniture wall part can be used, for example, as a side wall in case of wall units or floor units.

In particularly preferred embodiments, the inwardly pointing end faces of the skeleton structure form a planar support plane, to which a thin cover sheet, for example an HPL (high pressure laminate) sheet with a large selection of surface finishes, is applied in order to cover the open lattice structure. A cover sheet can also be applied to, or a cover film can be laminated onto, the outer wall, but this is not required. It is customary in kitchen construction to mount a cover on the outside merely on the visible furniture carcass, such that the wood-based side wall parts can be delivered with an untreated exterior. The low thickness of the plastic furniture wall part according to the invention, including HPL covering, of preferably 16 mm, which corresponds to the customary wood-based side walls in kitchen construction, should be highlighted.

Further advantages of the invention will emerge from the description, the claims and the drawing. Likewise, the features stated above and those still to be specified can be used each on their own account or multiply in any desired combinations. The embodiments which are shown and described are not to be understood as an exhaustive list, but rather have an exemplary character for describing the invention.

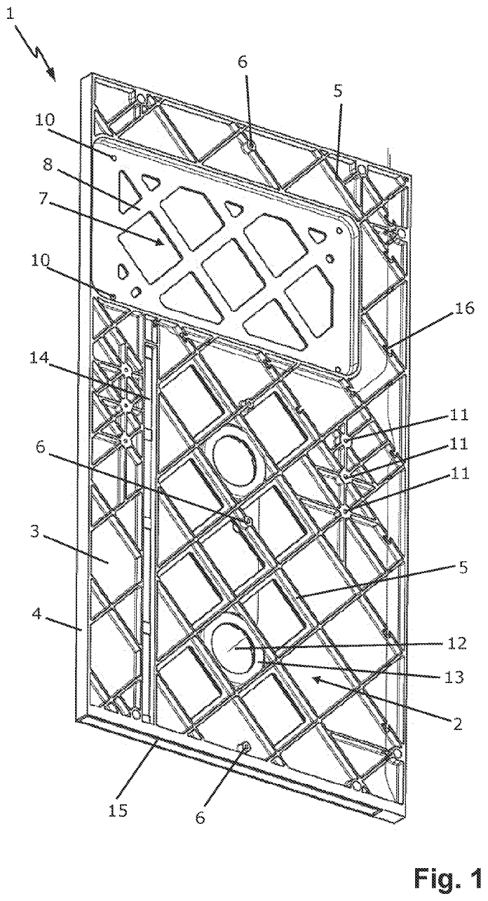

FIG. 1 shows a plastic furniture wall part according to the invention in a perspective view of the inner side.

### BRIEF DESCRIPTION OF THE DRAWINGS

The side wall part 1, shown in FIG. 1, of an item of furniture is a one-part plastic injection-molded part and has a lattice-like skeleton structure 2 which is closed toward the outside by an outer wall 3 and is open toward the inside. The skeleton structure 2 comprises an encircling outer frame 4 and a multiplicity of lattice struts 5, which run diagonally here by way of example, therebetween. To fasten the side wall part 1 to a carcass or a room wall, the skeleton structure 2 has, in the lattice struts 5, a plurality of (here merely by way of example four) fastening holes 6 for receiving customary connecting fittings, preferably connector bolts and dowels.

The skeleton structure 2 has, at the top, an inwardly open recess 7 for receiving a furniture fitting, such as for example a flap fitting or hinge. The recess 7 terminates toward the outside with a lattice-like base 8, which has a plurality of integrated threaded holes 10 for fastening screws of the furniture fitting. The skeleton structure 2 also has a plurality of recesses in the form of fastening holes 11, which are arranged in two vertical hole rows having a plurality of fastening holes 11, in order to receive therein, at the respectively desired height, for example fastening pins for shelves or fastening screws for a pull-out guide. As an alternative, the skeleton structure 2 may also have one or more inwardly protruding functional elements, such as for example a pin. In the region of the fastening holes 11, the skeleton structure 2 is reinforced by a higher number of lattice struts 5. The skeleton structure also has one or more recesses 12, having a for example ring-shaped base 13, for receiving a respective loudspeaker. An inwardly open vertical channel 14, in which an LED light strip can be laid, runs in the skeleton structure 2. A groove 15 for receiving an LED light strip can also run on the outer side in one or more of the frame sides of the outer frame 4. Some of the lattice struts 5 have cable leadthroughs in the form of inwardly open cutouts 16, in order for electrical cables to the installed electrical components (for example loudspeaker, LED light strip) to be laid therein.

The inwardly pointing end faces of the outer frame 4 and of the lattice struts 5 define a planar support plane, to which a thin cover sheet, for example an HPL sheet with a large selection of surface finishes, can be applied. A cover sheet can be applied to, or a cover film can be laminated onto, the outer wall 3, but this is not required. The side wall part 1, including the HPL covering, advantageously has a thickness of at maximum only 16 mm, which corresponds to the customary thicknesses of wood-based side walls in kitchen construction.

What is claimed is:

1. A one-part plastic furniture wall part, comprising:
a lattice-like skeleton structure which is closed toward the outside by an outer wall and is open toward the inside;
wherein the skeleton structure comprises at least one inwardly open recess for receiving a furniture fitting or an electrical component and/or at least one inwardly protruding functional element.

2. The plastic furniture wall part as claimed in claim 1, wherein the skeleton structure comprises fastening holes for fastening of the plastic furniture wall.

3. The plastic furniture wall part as claimed in claim 1, wherein the recess comprises a base toward the outside.

4. The plastic furniture wall part as claimed in claim 3, wherein the base comprises fastening holes for fastening screws of the furniture fitting.

5. The plastic furniture wall part as claimed in claim 1, wherein the skeleton structure is reinforced in the region of the recess by a higher number of lattice struts.

6. The plastic furniture wall part as claimed in claim 1, wherein the recess is designed to receive a furniture hinge or a pull-out guide.

7. The plastic furniture wall part as claimed in claim 1, wherein the recess is designed to receive a fastening means.

8. The plastic furniture wall part as claimed in claim 1, wherein the recess is designed to receive a loudspeaker.

9. The plastic furniture wall part as claimed in claim 1, wherein the recess is designed to receive a light strip.

10. The plastic furniture wall part as claimed in claim 1, wherein the skeleton structure comprises cutouts for cable leadthroughs.

11. The plastic furniture wall part as claimed in claim 1, wherein the inwardly pointing end faces of the skeleton structure form a planar support plane.

12. The plastic furniture wall part as claimed in claim 11, wherein a cover sheet is applied to the planar support plane.

13. The plastic furniture wall part as claimed in claim 1, wherein a cover sheet is applied to, or a cover film is laminated onto, the outer wall.
